(19) United States
(12) Patent Application Publication
(10) Pub. No.: US 2026/0141380 A1
(43) Pub. Date: May 21, 2026

(54) DATA OBJECTS WITH PRIVACY-PRESERVING REFERENTIAL INTEGRITY AND MATCHING OF SAME

(71) Applicant: Goldman Sachs & Co. LLC, New York, NY (US)

(72) Inventors: Chi Kit YIP, Hong Kong (HK); Chong Kiat Joseph CHUA, Singapore (SG); Manoj PREMA RAMESH, Singapore (SG); Chin Wan LAM, Hong Kong (HK); Brijesh GUPTA, Hong Kong (HK); Philipp WENDELING, London (GB); George PAULOSE, London (GB); Mathew MCDERMOTT, London (GB); Amar AMLANI, London (GB)

(21) Appl. No.: 19/170,827

(22) Filed: Apr. 4, 2025

Related U.S. Application Data
(60) Provisional application No. 63/722,701, filed on Nov. 20, 2024.

(51) Int. Cl. G06Q 20/38

(52) U.S. Cl. CPC G06Q 20/389

(57) ABSTRACT

A projection smart contract includes a synchronized copy of a subset of data held in a private smart contract. The subset of data can include information required for an interaction with another private smart contract while omitting data from the first private smart contract that need not be shared for the transaction. The projection can also be permissioned to limit availability of even the subset of data to parties that require access to the subset of information. Thus, data can be shared between private smart contracts without disclosing private information within those smart contracts.

### CROSS-REFERENCE TO RELATED APPLICATION

This Application claims the benefit of U.S. Provisional Patent Application No. 63/722,701, filed Nov. 20, 2024, which is incorporated by reference.

### TECHNICAL FIELD

The disclosure relates generally to the field of distributed ledger technology (DLT), and, in particular, to a digital assets platform that can provide end-to-end registry, custody, issuance, trading, settlement, and servicing of digital assets and tokenized assets.

### BACKGROUND

Distributed ledger technology (e.g., blockchains) was developed as a means for parties to engage in transactions, e.g., financial transactions, without the need for a single, centralized authority or intermediary. In such DLT-based systems, each transaction is recorded independently by several nodes. In some implementations, no single entity controls all of the nodes so it is exceedingly difficult for a malicious actor to alter the transaction once it has been recorded by the nodes. Even in implementations where a single entity controls all of the nodes, it is still exceedingly difficult to alter the data recorded on sufficient nodes to change the consensus indicated by all of the nodes without leaving an indication that the data has been tampered with.

There are many scenarios where it is desirable for parties to exchange digital assets, either for other digital assets, cash, or non-digital assets. Market participants desire a wide range of functionality with digital assets to mirror the rich tapestry of financial products that are possible with conventional, non-digital approaches. However, conventional digital asset systems provide only a patchwork of functionality that meet only a subset of the demands of financial market participants. Furthermore, regulatory requirements vary by jurisdiction, meaning that systems developed to serve market participants in one place may not be viable solutions in another where the regulatory requirements differ. Thus, there is a need for a new piece of DLT based Financial Market Infrastructure (FMI) that addresses intra-and inter-jurisdictional fragmentation and inefficiency in existing digital asset systems that provides, for example, end-to-end registry, custody, issuance, trading, settlement, and servicing of digital assets and tokenized assets (including securities and non-securities). There is also a need for such technology to be scalable and adaptable to support a wide range of scenarios.

### SUMMARY

Described embodiments leverage the underlying blockchain's design to enhance privacy by ensuring that the state associated with each interaction is isolated and accessible only to the relevant signatories and authorized observers. Unlike systems where a shared global state is visible to all participants, this approach limits visibility to only those directly involved. By confining access to the state in this manner, the system prevents unauthorized disclosure of sensitive information, such that confidentiality is maintained without compromising the security or functionality of the overall system.

Various embodiments include a digital assets platform (“DAP” or the “platform”) that uses distributed ledger technology (DLT) and smart contract programming. The DAP can include distributed and decentralized communication network and application systems that collectively provide end-to-end tokenization, management, and lifecycle processing of digital assets. The assets may be digitally native securities (e.g., bonds, equities, funds, etc.) and non-securities (e.g., digital cash, loans, derivatives), tokenization of real-world assets (securities and non-securities), or any other forms of tokenized assets (collectively, “digital assets”).

To comply with regulatory requirements with respect to securities and non-securities in many jurisdictions, the platform may use a permissioned DLT network (e.g., a permissioned private or consortium blockchain) for which the nodes are hosted and operated by recognized and legitimate institutions (e.g., regulated financial institutions). In various embodiments the specific data structures and infrastructure configurations of the DAP may: deliver a platform for tokenization, administration and trading of (regulated) digital assets; reduce time-to-market of DLT-based products by building asset-agnostic product and servicing layers and cross-asset class digitization workflows along with minimizing the effort to onboard new asset class instruments or workflows; enable external participants to access a wide range of digital asset products with single platform onboarding; facilitate participants structuring new asset and asset exchange structures; and provide interoperability with existing industry infrastructure and other DLT blockchain networks.

Embodiments of the platform enable enhanced privacy in blockchain-based settlements, safeguarding both account balances and transaction instructions by using temporary, transaction-specific account projections that serve as intermediaries during the settlement process. Using these temporary account projections, sensitive account information (e.g., total account balances) of the users involved in the transaction remain hidden while making information necessary for settlement available to the relevant entities and the entities of observers (e.g., the custodians of the parties to a transaction) remain hidden from each other.

In addition to concealing account information, settlement instructions can remain entirely private. In one embodiment, the settlement instructions are not visible even to the counterparties involved in the transaction. Instead, they are accessible only to the settler and the custodians of the instruction creators. This ensures that no unauthorized party, including other blockchain participants, can view or deduce the details of the settlement. The confidentiality of these instructions protects sensitive transactional data and prevents information leakage.

To facilitate the completion of transactions while preserving this high level of privacy, various embodiments employ a dedicated component referred to as the settlement agent (SA). The SA is responsible for collecting and processing the individual settlement instruction from the network. The SA matches the instructions, without revealing their content to anyone other than the authorized parties. Privacy is maintained through the settlement process without compromising its efficiency or reliability by enabling only those parties (e.g., signatories and observers) that need access to the settlement instructions (and other sensitive information) access to such information using a smart contract driven privacy model (e.g., a DAML privacy model). Moreover, assertions may be imposed on the smart contracts themselves to ensure that settlement instructions are not matched incorrectly (whether maliciously or by accident).

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram that illustrates a networked computing environment suitable for providing end-to-end registry, custody, issuance, trading, settlement, and servicing of digital assets and tokenized assets, according to one embodiment.

FIG. 2 is a block diagram of the digital assets platform of FIG. 1, according to one embodiment.

FIG. 3 is a block diagram of a smart contract application that splits the definition and functionality for a digital asset into three layers, according to one embodiment.

FIG. 4A is a block diagram illustrating one configuration of bilateral projection smart contracts to share data between entities while retaining privacy for those entities, according to one embodiment.

FIG. 4B is a block diagram illustrating another configuration of bilateral projection smart contracts to share data between entities while retaining privacy for those entities, according to one embodiment.

FIG. 5 is a diagram illustrating safe disclosure of instructions to enable trusted atomic settlement, according to one embodiment.

FIG. 6 is a block diagram illustrating batching of instructions to enable trusted atomic settlement that retains counterparty privacy, according to one embodiment.

FIG. 7 is a block diagram illustrating the movement of assets for a transaction using self-contained owned instruction smart contracts with batching and atomic settlement, according to one embodiment.

FIG. 8 illustrates batch and owned instructions smart contracts for implementing batching and atomic settlement, according to one embodiment.

FIG. 9 is a block diagram illustrating a specific example of the batching of instructions and atomic settlement, according to one embodiment.

FIG. 10 illustrates a set of smart contracts and the corresponding access permissions for implementing the batching and atomic settlement illustrated in FIG. 9, according to one embodiment.

FIGS. 11A through 11E illustrate a set of detailed batch and settlement objects after being batched together thar are ready to be settled, according to one embodiment.

FIG. 12 is a block diagram of a set of accounts using hierarchical claim tokens to provide secondary and tertiary interests in a digital asset, according to one embodiment.

FIG. 13 is a flowchart illustrating a method of verifying consistency between smart contracts while preserving privacy, according to one embodiment.

FIG. 14 is a flowchart illustrating a method of atomically settling a set of settlement instruction, according to one embodiment.

FIG. 15 is a block diagram of an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

A DAP generally settles, or facilitates the settlement of, transactions involving digital assets, leveraging distributed ledger technology to digitize end-to-end lifecycle processes. The DAP includes technical innovations to address one or more problems that arise in the transfer of digital assets in a distributed ledger (e.g., blockchain) environment. For example, privacy is a significant concern for many participants. Using conventional distributed ledger systems, a party's full account information, such as transaction history, can be available for public inspection. To address this, various embodiments of the DAP use a novel type of smart contract, referred to as a projection, that includes a synchronized copy of a subset of data held in a private smart contract. The subset of data can include information required for a transaction (e.g., settlement) while omitting data from the private smart contract that need not be shared for the transaction. The projection can also be permissioned to limit availability of even the subset of data to parties that require access to the subset of information. The DAP may also include other technical innovations to solve problems with conventional distributed ledger systems, such as modular asset definitions that split the definitions of assets up into multiple layers, each of which may be independently modified to provide for easier updating, and batched settlement that ensures there are valid links between all sets of settlement instructions involved in a transaction before execution such that either all of the settlement instructions execute together atomically or none of the settlement instructions are executed.

It should be appreciated that projection smart contracts (and the other disclosed innovations) may be used in a wide range of scenarios, including use cases outside of the context of the DAP. The following description first describes an example DAP with various functionality to provide context for the disclosed innovations before explaining how these innovations can be practically applied in this context. However, the example DAP should not be considered limiting on the scope of the claimed innovations. It is merely provided to provide a contextual example and aid the reader in understanding the innovations.

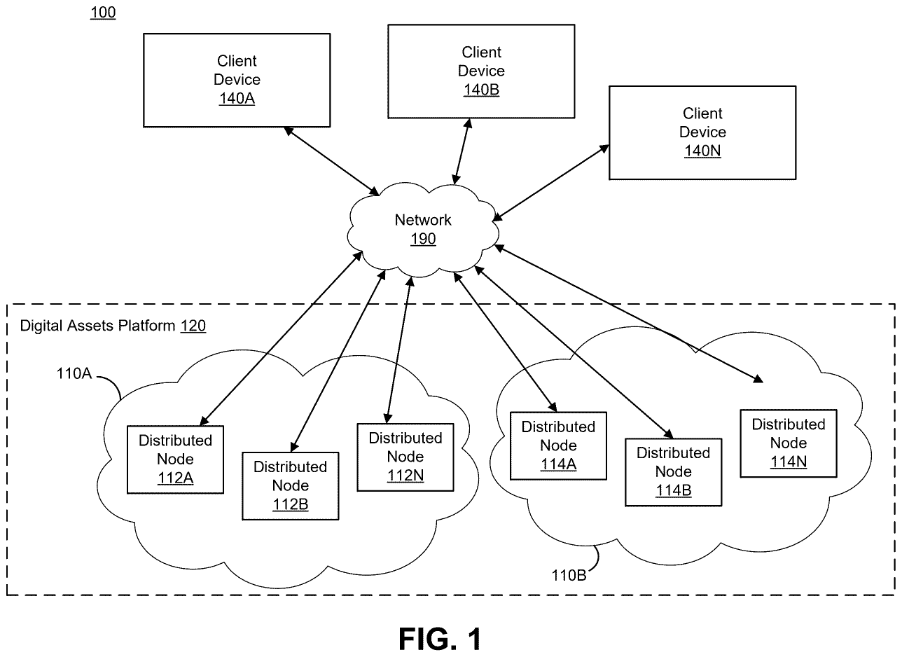

FIG. 1 illustrates one embodiment of a networked computing environment 100 environment suitable for providing end-to-end registry, custody, issuance, batch trading, settlement, and servicing of digital assets and tokenized assets while retaining privacy between counterparties. In the embodiment shown, the networked computing environment 100 includes a digital assets platform 120, one or more distributed ledgers 110, and one or more client devices 140, all connected via a network 190. In other embodiments, the networked computing environment 100 includes fewer, different, or additional elements. In addition, the functions may be distributed among the elements in a different manner than described.

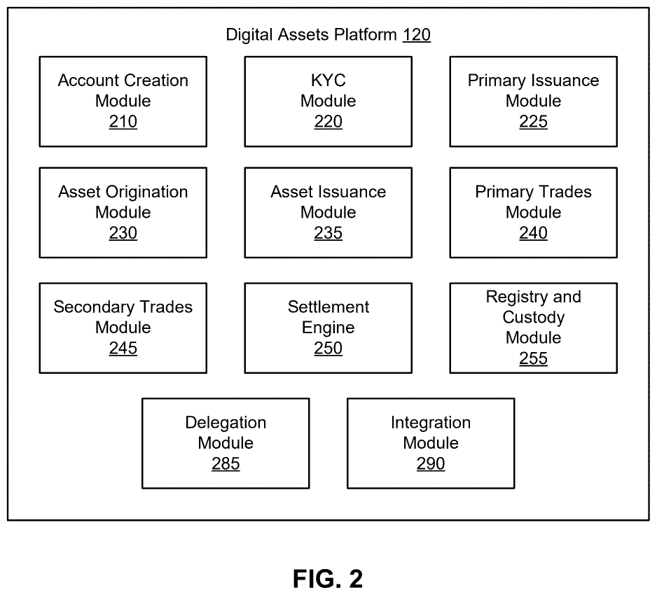

The digital assets platform 120 includes one or more computing devices that collectively provide functionality for digital and tokenized assets, including end-to-end registry, custody, issuance, trading, batch settlement, and servicing of those assets, while enabling privacy between counterparties. These computing devices include the nodes of one or more distributed ledgers (e.g., distributed ledger 110A or 110B). The digital assets platform 120 provides information to drive user interfaces (e.g., at client devices 140) for market participants to make transactions involving digital assets. The digital assets platform 120 creates and manages smart contracts on one or more distributed ledgers 110 (e.g., blockchains) to provide the aforementioned functionality. Various embodiments of the digital assets platform 120 are described in greater detail below, with reference to FIG. 2.

The distributed ledgers 110 provide an immutable record indicating the current and historical ownership of digital and tokenized assets. The distributed ledgers also contain smart contracts that provide functionality regarding the digital and tokenized assets. FIG. 1 shows two distributed ledgers 110A and 110B for illustrative purposes. In practice, the networked computing environment 100 may include any number of distributed ledgers. For example, in one embodiment, a single, permissioned distributed ledger is used to store all digital assets and smart contracts while in another embodiment, the platform may support multiple types of digital asset, each of which is stored on its own distributed ledger. Furthermore, in some embodiments, the platform may use a separate distributed ledger for storing smart contracts than those used to stored digital or tokenized assets.

In FIG. 1, the first distributed ledger 110A is shown as including three distributed nodes 112, a first distributed node 112A, a second distributed node 112B, and an Nth distributed node 112N. Similarly, the second distributed ledger 110B is shown as including a first distributed node 114A, a second distributed node 114B, and an Nth distributed node 114N. In practice, each distributed ledger 110 can (and likely will) include many more nodes.

The distributed nodes 112, 114 are computing devices. The distributed nodes may manage and provide a blockchain or other type of distributed ledger. The distributed nodes can also store and execute the rules set by a smart contract. Thus, when the triggering conditions of a smart contract are met, one or more operations may be automatically performed by the distributed nodes 112, 114. When an event or data relevant to a smart contract is generated, relevant information may be added to a block of the blockchain. The blockchain and smart contract can codify and automatically enforce rules governing ownership of and investment in digital assets. Entities participating in the DAP may manage one or more distributed nodes 112, 114. In some embodiments, the entity controlling a node can assign roles indicating what permissions different parties have regarding that node. Thus, different parties may have different roles for different nodes enabling true decentralization.

When a distributed node 112 or 114 receives a request to conduct a transaction it confirms or denies whether the relevant data of the transaction is consistent with its records. A transaction is considered successfully verified if a threshold amount of the distributed nodes agree that the transaction is consistent with their records. For example, a Byzantine fault tolerance approach may be used to determine whether sufficient nodes confirm the validity of a transaction to verify the transaction. Similarly, an action defined in a rule of a smart contract may be triggered if a threshold amount of the distributed nodes agree that a triggering condition for the action has been met.

A distributed ledger 110 generally takes one the following forms:
A single global ledger which is maintained by all the nodes within the blockchain network; or
A global ledger which is made up of multiple local ledgers which are maintained by the individual nodes within the network.

In DLT embodiments that use a single global ledger, when a change to the blockchain is made (e.g., when a new transaction or block is created), the nodes form a consensus as to how the change is integrated into the network of distributed nodes. Upon consensus, the agreed upon change is considered confirmed such that each node maintains a copy that should match the copies stored by other nodes. Any change that does not achieve a consensus may be ignored. Accordingly, unlike a traditional, centralized ledger, a single party cannot unilaterally alter the blockchain.

In embodiments of DLT that use a global ledger made up of multiple local ledgers, when a transaction is submitted to the network, the involved nodes validate and provide the confirmation of the validity of the transaction. Upon consensus, the agreed upon change is considered confirmed and shall be used to update the contract states within the local ledger of the relevant nodes. Unlike in embodiments that use a single global ledger, each of the nodes maintains its own private state of the ledger, which collectively forms the global ledger.

The blockchain may also include smart contracts, which are a set of executable instructions stored in conjunction with one or more triggering conditions. If the triggering conditions are met, the smart contract is triggered to execute the corresponding instructions. Each distributed node 112, 114 may receive the definition of a smart contract but any outcomes resulting from execution of the code within the smart contract are only validated if consensus is reached among the nodes as to the state of the smart contract (e.g., sufficient nodes agree that the triggering conditions have been met and execution of the instructions leads to a particular outcome). In other embodiments, other types of distributed ledger may be used.

The client devices 140 are computing devices with which users may interact with the digital assets platform 120 or a distributed ledger, such as distributed ledger 110A or distributed ledger 110B. Although three client devices (a first client device 140A, a second client device 140B, and an Nth client device 140N) are shown, in practice, the networked computing environment 100 can include any number of such devices. In one embodiment, the client devices 140 provide a user interface (e.g., in a browser or via a dedicated app) with which market participants can provide details of transactions, apply their digital signatures to transactions, view their prior activity on the platform, and access other functionality of the platform (such as any of the functionality described below).

The network 190 provides the communication channels via which the other elements of the networked computing environment 100 communicate. The network 190 can include any combination of local area or wide area networks, using both wired or wireless communication systems. In one embodiment, the network 190 uses standard communications technologies or protocols. For example, the network 190 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 190 include multiprotocol label switching (MPLS), gRPC Remote Procedure Calls (GRPC), transmission control protocol/Internet protocol (TCP/IP), hypertext transport protocol (HTTP), simple mail transfer protocol (SMTP), and file transfer protocol (FTP). Data exchanged over the network 190 may be represented using any suitable format, such as hypertext markup language (HTML) or extensible markup language (XML). In some embodiments, all or some of the communication links of the network 190 may be encrypted using any suitable technique or techniques.

### Example Digital Assets Platform

FIG. 2 illustrates one embodiment of the digital assets platform 120. In the embodiment shown, the platform 120 includes a role assignment module 205, an account creation module 210, an account management module 215, a KYC module 220, a primary issuance module 225, an asset origination module 230, an asset issuance module 235, a primary trades module 240, a secondary trades module 245, a settlement engine 250, a registry and custody module 255, a reconciliation module 260, an asset model module 265, a validation module 270, an coupon payment module 275, a redemption module 280, a delegation module 285, and an integration module 290. In other embodiments, the platform 120 includes different or additional elements. Furthermore, the functionality may be distributed between the components of the platform 120 differently than described. For example, the platform 120 is shown as having a role assignment module 205, in some embodiments, roles are assigned per node by the entities managing each node, as described previously.

The account creation module 210 module creates accounts for entities that use the platform. In one embodiment, account creation involves two parties, an account provider and an account owner. An account provider is an entity that has the Custodian role while an account owner may be any entity on the platform 120. The account is represented on chain by a smart contract that includes identifiers of the account, provider, and owner, as well as the KYC status of the account. Generally, it is the responsibility of the account provider to maintain/update the KYC status of the account.

The KYC module 220 provides an interface (e.g., via a client device 140) for account providers to update the KYC status of accounts. The account providers can operate their usual KYC procedures off chain and of there is a change in the KYC status of an account holder, the account provider may use the interface provided by the KYC module 220 to add a new smart contract to the distributed ledger (which supersedes any earlier smart contract for the account) indicating the updated KYC status. Alternatively, the smart contract for an account may indicate an off-chain location where the KYC status of the account is stored and the account provider may update the KYC status stored at that location, automatically making the updated KYC status available on chain. In other embodiments, an oracle may be specified for the blockchain for providing KYC confirmation.

The primary issuance module 225, if included, manages primary issuances of one or more issuances (e.g., tranches) of a digital asset as part of a deal. In one embodiment, the primary issuance process starts off with the lead party/parties (e.g., a lead bank for a syndicate issuance) creating the deal. The deal is defined as a collection of one or more issuances grouped under the same issuer and lead bank party. Each issuance represents an issuance lifecycle (e.g., a syndicate issuance, a private placement issuance, a municipal bond issuance, etc.) with different sets of participants and digital assets involved. The primary issuance and book building workflows are decoupled from the digital assets instrument to achieve maximum flexibility. Within each issuance, the lead party specified is responsible for managing the issuance workflow. The workflow can also be configured to include different visibility levels, book building stages, allowed participants, and actions.

During the issuance process, the lead party updates the issuance with different states to represent the different stage of the issuance (e.g., announced, book open, book closed, launched, allocated, priced, cancelled). For each issuance, the allocation and price discovery can be set to manual with the help of an underwriter or crowd sourced through auctions. The book building process can be completed on-chain or performed off-chain and then fed into the platform 120 and recorded on the ledger via directly using the platform UI or API to manage and execute the book building on-chain or integration with a traditional book-building system that feeds the resulting deals, orders, and allocation information into the platform 120 to be recorded on the distributed ledger.

Once the price for an issuance has been set, the asset origination module 230 and the asset issuance module 235 work together to issue the digital assets. In one embodiment, asset origination and issuance on the platform 120 involves two parties, the issuer and the registrar. Issuance and instrument services are established between the issuer and registrar before Asset origination and issuance commences. Assuming that the required services are in place, issuance and origination of the digital assets are treated as two distinct processes. Origination creates a smart contract that includes a description of the digital asset (or an instrument defining the digital asset) but does not denote the legal creation or ownership of a digital asset. In contrast, issuance creates tokens that represent instances of the digital asset and assigns ownership of those tokens on chain. The individual tokens do not include the description of the digital asset but rather refer back to the smart contract created during origination. Thus, only one instance of the description of the digital asset is stored on chain, which can improve efficiency and eliminate the risk of inconsistent definitions between instances.

Additionally or alternatively, rather than an asset being issued natively on the platform, the DAP 120 may integrate with a bookbuilding platform that handles asset issuance. Once an asset has been defined using the bookbuilding platform, instances of the asset may be tokenized on-chain to enable the DAP 120 to provide settlement and other services relating to the asset.

In the context of DLT, the existing monolithic smart contract architectures pose significant challenges, and would benefit from a solution that provides frequent, safer, and easier upgrades; resilience and node hosting across multiple participants within the same blockchain network; and asset interoperability. In particular, in some embodiments, the DAP enables users to define an asset using smart contract applications with three layers, decoupling different parts of the asset definition and functionality.

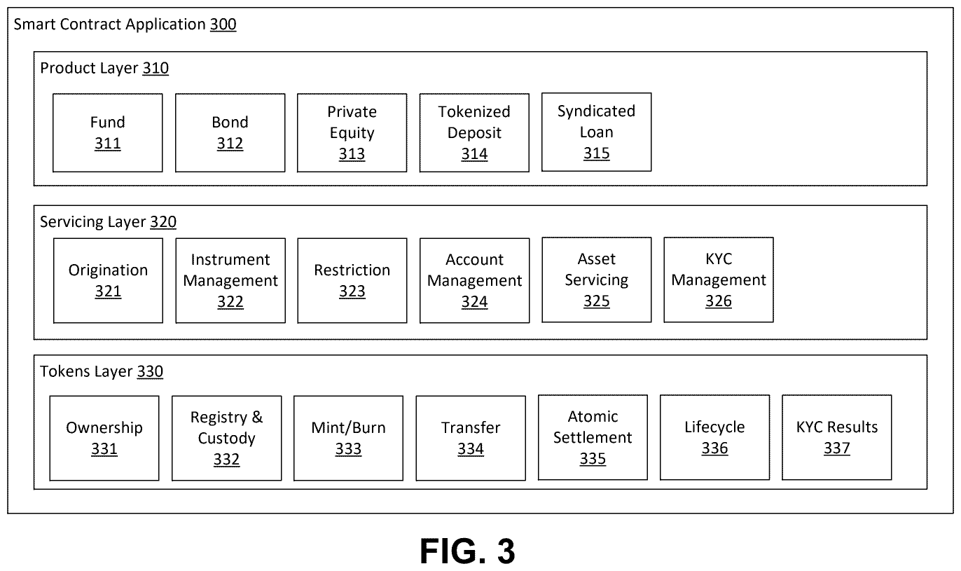

FIG. 3 illustrates a smart contract application 300 with three layers that enables the creation of custom assets. In the embodiment shown, the smart contract application includes a product layer 310, a servicing layer 320, and a tokens layer 330.

The product layer 310 includes definitions of various types of digital asset, such as funds 311, bonds 312, private equity 313, tokenized deposits 314, and syndicated loans 315. Each product is defined (and is thus different) in the product layer 310. However, the product layer 310 may provide primitives for each product type enabling easy creation of new products of each type by users by providing relevant information (e.g., initial pricing, terms and conditions, etc.).

The servicing layer 320 provides asset-agnostic workflows for product administration, issuance, distribution, settlement, and servicing for assets defined in the product layer 310. In one embodiment, the services provided by the servicing layer 320 include origination 321, instrument management 322, restriction (e.g., pre- and post-trade, instrument, and account restrictions) 323, account management 324, asset servicing 325, and KYC management 326.

Similarly, the tokens layer 330 provides product-agnostic services for tokenization, safe-keeping and transfer of digitally native and real assets. In one embodiment, the services provided by the tokens layer 330 include ownership tracking 331, registry and custody services 332, minting and burning of tokens 333, transfer of tokens 334, atomic settlement 335, token lifecycle management 336, and KYC result reporting 337. The smart contract application structure enables more frequent, safer, easier upgrades by modularizing the smart contract codebase into three-tiered, small fine-grained units that can be composed to build higher-level functionality, and support “selective module upgrade.” This structure also supports distributed node hosting by using interface-based upgradability design patterns in all layers to enable upgrades to be executed with low risk to data loss or corruption, which enables the interoperability that is typically provided by a single-codebase approach. Design patterns (e.g., proof contracts, subscriber contracts, or reference counters) may be used in some or all of the layers to provide enhanced resiliency, reduced collateral data disclosure, and on-chain guarantees of referential integrity. Furthermore, because two of the three layers are asset agnostic, creating new types of assets is simple and efficient. The asset is simply defined in the product layer 310 and then the existing functionality provided by the servicing layer 320 and tokens layer 330 can be applied to manage instances of the new asset.

Referring again to FIG. 2, the primary trades module 240, if included, manages primary trades of digital assets. In one embodiment, the primary trade module 240 supports a wide variety of trades that may be structured with various hierarchies (including a flat issuance scheme with no hierarchy). Example types of trades that are supported include: (1) takedown trades (trades between the issuer and lead bank to take down the full issuance); (2) investor trades (trades between investors and banks to purchase digital assets); (3) residual trades (sharing of residual unallocated assets between syndicate banks in the event of an undersubscription); (4) broker trades (trades between the lead bank and a syndicate bank to allow the syndicate bank to settle directly with its own investors); and (5) direct allocation trades (trades between the issuer and the investor). The lead bank can book these primary trades in the platform 120 based on the issuance size as well as the investors'orders submitted during the book building phase. As with the primary issuance module 225, in some embodiments, rather than providing trading functionality natively, the DAP 120 may integrate with external trading systems/venues to enable settlement of primary and/or secondary trades in digital assets.

Regardless of the specific platform configuration, once trades are booked, a settlement agent can generate settlement instructions for the trades. In one embodiment, the settlement instructions are generated by traversing a custodial hierarchy tree using an algorithm that ensures there is a valid path between the buyer and the seller. The generation of settlement instructions can be manually triggered or automated based on one or more criteria having been met. The settlement instructions are generated based on the information retrieved from the trades and the settlement information of the respective counterparties. The settlement instructions are then signed by the relevant parties (e.g., buyer, seller, custodians), and proceed to the assets settlement transfer (e.g., DvP/FoP).

The secondary trades module 245, if included versus being provided by integration with an external trading system, enables trading of ownership and beneficial interests in digital assets in a secondary market. In one embodiment, the secondary trades module 245 provides a bulletin board (e.g., accessible via client devices 140) on which secondary traders may post IOIs for digital assets. If another secondary trader is interested in the IOI, the secondary traders can discuss and, assuming they can agree on terms, agree to a trade. Once the two parties have agreed, either one of them can initiate creation of a trade recap. Once a party creates a request for a trade recap using the user interface, the other party can confirm that submission. Assuming confirmation is provided, a settlement agent initiates settlement, starting with the creation of a trade. From there, the settlement proceeds in the same way as in primary issuance or any other trading context.

In one embodiment, the secondary trades module 245 provides efficient trade recap matching. In conventional trade-matching systems that do not involve a distributed ledger, the system can query a database of trade information for all trades that meet a specified set of criteria. However, when using a distributed ledger, retrieving trades information is limited to keyed lookups, making identifying matches more difficult.

To address this, when the platform 120 receives counter party trade recaps, it stores them on chain in a custom queue. The queue rebalances to always return the earliest matching (or latest, depending on the specific requirements of the implementation) opposite side trade recap. The self-ordering queue can be implemented as an immutable contract object in DAML (or any other suitable form of smart contract). The queue does not use any additional object to store the ordering and is self-contained. In one embodiment, the queue is a virtual balancing queue, meaning that it does not need any more data storage nor use any other data structure beyond creating a smart contract for the single-sided trade. In other traditional implementations of a queue, additional data structures are often used with properties such that elements in the queue will be removed in the order it was added. However, the virtual queue is realized through existing smart contracts that are keyed with the iterative key.

To enable efficient lookups from the queue, each side of the trades are keyed with trade economics and an iterative key. An iterative key is one that can be used in an iteration algorithm for searching while also guaranteeing uniqueness. When the platform ingests one side of the trade, the platform 120 performs iterative keyed lookups for other trades with the same economics but with the opposite side. If it finds a match, then the two sides of the trade are matched. The queue rebalances such that if there are multiple potential matches, either the earliest or latest potential match is returned, depending on the specific implementation of the queue. Conversely, if no match is found, then the trade is stored in the virtual balancing queue.

If allowed by the relevant regulatory requirements, the platform 120 may provide electronic trading capability to provide better liquidity management post the issuance of the digital assets. For example, the platform 120 may provide one or more of: multilateral continuous order matching, multilateral auction matching, or bilateral or multilateral RFQs and RFT interactions. This may be achieved using an electronic trading engine within the platform 120 or integration with an existing trading engine (e.g., via an API).

The settlement engine 250 is responsible for the settlement process. In one embodiment, the generated settlement instructions are signed by both sender and receiver and the trade is settled by the settlement agent. The settlement agent settles the trade atomically, meaning either all assets involved in the trade are transferred or none are. In some embodiments, the settlement instructions can be used to settle even when one of the assets is in a different blockchain. Further details of how hash time-locked contracts (HTLCs) may be used to settle cross-chain transactions can be found in U.S. patent application Ser. No. 18/205,861, filed Jun. 5, 2023, which is incorporated by reference.

The settlement type may be decided based on the existence of delivery and payment assets and the type of assets. This enables the platform 120 to achieve the following types of settlements atomically: (1) delivery versus payment (DvP); (2) free of payment (FoP) and free of delivery (FoD); and (3) delivery versus delivery and payment versus payment. Because the platform 120 allows the representation of assets cross-chain, the settlement process can also support atomically settling a trade across two or more chains.

In various embodiments, the settlement engine 250 uses a settlement agent bot (which may be an always-running bot) to automate the DvP and FoP settlement process. The settlement engine 250 may use some or all of the following processes to provide automated or close to automated atomic settlement:
Add Settlement Agent To Trade Observers: the lead bank or an operator periodically fetches all of the visible trades in the open state and checks if there is any trade that does not have the settlement agent in the observers list. If such a trade is found, the settlement agent is added to the observers list.
Create Settlement Instructions: the settlement agent periodically fetches all of the visible trades (both primary issuance trades and secondary trading) in the open state and generates settlement instructions as appropriate.
Register Readiness for Settlement: the settlement agent periodically fetches all visible delivery/settlement templates attempts to mark them as fully signed by all required parties. This will throw an error if not all the counterparties have signed, meaning the instructions will not actually be implemented prematurely with the need for off-chain checks. This process checks if all settlement instructions for the trade have been signed by both sides. If all those signatures are in place, it means that the trade is ready to settle. If all of the signatures are in place it will set a Boolean on any HTLC-locked settlement instructions to indicate that all the signatures are in place. This lets a buyer HTLC-Connector bot, which does not have the ability to check that all parties have provided the required signatures itself, know that everything is ready for execution.
Settle Trades: the settlement agent periodically fetches all visible delivery/settlement templates and attempts to execute their settlement instruction choices. These will throw an error if not all the counterparties have signed, so the settlement agent can call these instructions, causing those that are ready for execution to be executed while those that are not will remain unexecuted without the need for off-chain checks.
Automation for Asset Servicing: the settlement agent periodically settles any pending coupon payments.
Cancel Settlement for Cancelled Trades: the settlement agent periodically fetches all settlements and tries to cancel them. A settlement will get cancelled only if the related trades are cancelled.
Send Trade Cancel/Advice SWIFT: the settlement agent periodically checks if there is a cancelled trade or a trade where an advice message is required and, if so, sends a SWIFT message if no message was sent before.
Cancel Invalid Trades: the settlement agent may cancel any trades which can no longer be settled.

In an alternative embodiment, the settlement engine 250 uses the following settlement workflow:
Instructions Creation and Disclosure: Counterparties instruct custodians via SWIFT, who then create settlement instructions on the platform and disclose the required holdings to the SA.
Batching of Instructions: The SA retrieves, matches, and batches the instructions based on settlement economics.
Instructions Allocation: The necessary holdings are allocated to the instructions which reserve and prevent the allocated holdings from being spent elsewhere, ensuring the settlement process is secure.
Execution or Cancellation of Settlement: On the settlement date, the SA verifies the completeness of the settlement route and executes the settlement, moving assets across on-chain accounts in a single atomic transaction. Instructions can also be canceled if necessary.

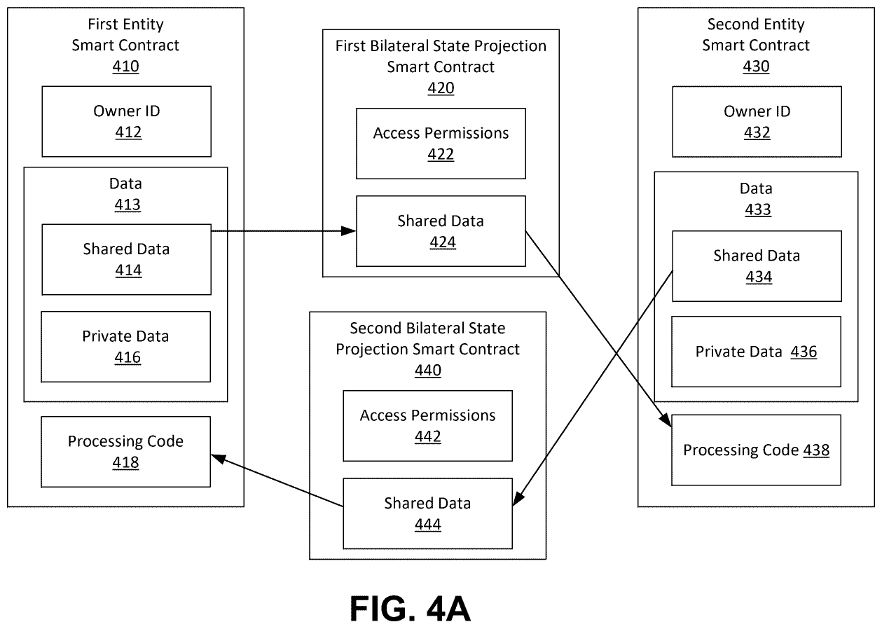

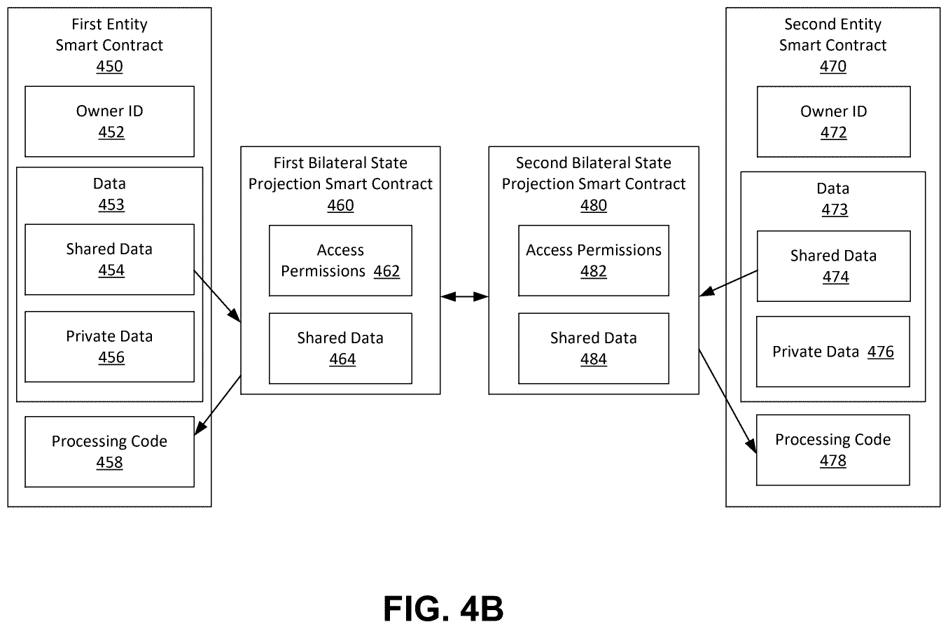

In some embodiments, the settlement engine 250 may batch multiple financial/settlement transactions into a single set of settlement instructions that are implemented in a single atomic settlement. This can improve efficiency of the settlement engine 250 and may be desirable in certain scenarios where implementing multiple transactions simultaneously is desirable. The use of bilateral state projection of accounts and templates to provide privacy-preserved atomic settlement is described in greater detail below, with reference to FIG. 4 through

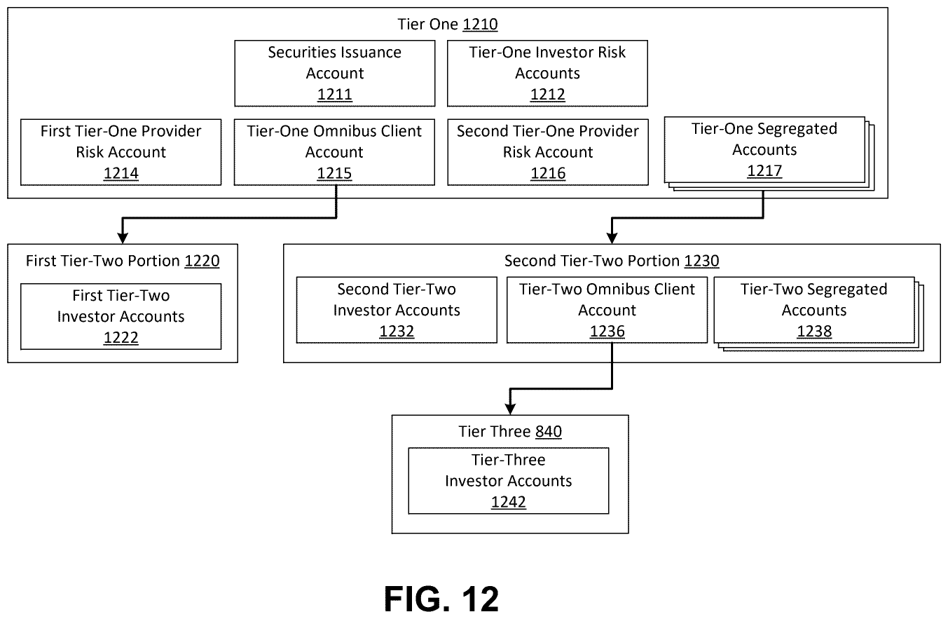

The asset registry and custody module 255 provides DLT-based on-chain registry and custody of digital assets. The wallet/account structure supporting the asset registry and custody can be flexible to support: (1) self-custody or custodian managed; (2) multi-tiered set-up to support custodian and sub-custodian relationship; (3) per-investor/beneficiary owner accounts or omnibus accounts for multiple investors/beneficiary owners; and (4) different wallet/account setups by jurisdiction to provide compliance to local regulations. With a multi-tiered approach, the registrar need only keep custody of the accounts it is immediately responsible for and not every account on the platform. It further allows the custodians to self-manage bookkeeping of the accounts they are responsible for. Further details of an example tiered hierarchical account structure that can be used by the DAP are provided below with reference to FIG. 12.

The delegation module 285 enables a party to delegate the right to make choices on its behalf in the platform 120 to another party. In one embodiment, delegation is used to break down the entitlements of a party to the department level. For example, the authority to sign settlement instructions for one deal may be delegated to a first department while the authority to sign settlement instructions for another deal may be delegated to a second department. In one embodiment, the delegation module 285 provides two types of delegation: party level delegation and service level delegation.

Party level delegation allows a single user to act as multiple parties. For example, in DAML there are two built-in concepts known as DAML party and DAML user (in other smart contract languages, similar concepts exist or may be defined). A DAML party represents an identity that can interact with the ledger by submitting DAML commands which result in the creation of DAML transactions and DAML contracts on the ledger. On the other hand, DAML users are local to a given participant node and are associated with a primary party and a dynamic set of actAs and readAs party/parties. A that which is associated to multiple DAML parties is able to act as these parties and submit DAML commands in these parties' capacity.

To provide a specific use case, an issuer may want to delegate its on-chain party's responsibility to another organization (for, e.g., Bank A and Custodian B). Under this scenario, the Custodian B user rights are defined to act as both the Bank A DAML party and Custodian B DAML party. With these entitlement rights, the Custodian B user is able to make use of Bank A DAML party identity to submit DAML commands (in Bank A capacity) which leads to creation of DAML transactions and DAML contracts (with Bank A party signatory).

Service level delegation is the usage of the on-chain delegation pattern to allow the delegated party the right to exercise a choice (within a service contract) on behalf of another party. As described previously, in some embodiments, each party is allocated to one or more roles. Each of the roles assigned comes with its own service DAML contracts that define the list of allowed actions that this role can perform. Under this setup, an on-chain delegation DAML contract can be created between the principle and delegate party that defines choices to allow the delegated party to make use of the issuer identity to exercise certain service contract choices.

The integration module 290 enables integration of the platform 120 with off-chain systems. In one embodiment, the integration module 290 enables an entity that does not operate a node in the platform 120 to participate in the platform via a node managed by another entity in a manner that still provides the entity confidence that its intentions are being faithfully executed. Specifically, the integration module 290 interacts with an off-chain system of the entity to enable the entity to inspect an API payload that will be submitted to the node being operated on its behalf. The entity can attach its signature using its off-chain system and the integration module 290 retrieve this signature via a webhook. The integration module 290 adds the retrieved signature along with the transaction details to the blockchain in a smart contract. Thus, the entity can verify at any time that the on-chain information matches what it initially signed using the off-chain system.

### Using Projections for Privacy-Preserved Atomic Settlement

In some embodiments, bilateral state projections (BSPs) may be used to enable counterparties to verify the accuracy of relevant information while preserving the privacy of the parties. A BSP is a smart contract that is viewable by two sets of parties (bilateral) and contains a partial copy (projection) of the state of another smart contract. FIG. 4A illustrates an example of BSPs being used by smart contracts to share a subset of data (and potentially functionality) between smart contracts without compromising the privacy of either party. A first entity smart contract 410 includes an identifier of the owner 412 (e.g., an LEI), data 413, which includes both shared data 414 (that the first entity is willing for the second entity to see) and private data 416 (which the first entity does not wish to disclose to the second entity), and processing code 418. Similarly, a second entity smart contract 430 includes an identifier of the owner 432 (e.g., an LEI), data 433, which includes both shared data 434 (that the second entity is willing for the first entity to see) and private data 436 (which the second entity does not wish to disclose to the first entity), and processing code 438

A first bilateral projection smart contract 420 includes access permissions 422 and shared data 424. The access permissions 422 indicate that the first and second entities (and potentially other relevant entities, such as custodians of the first and second entities) can access the shared data 424. The shared data 424 includes a copy of the shared data 414 from the first entity smart contract 410, but not a copy of the private data 416. Thus, the second entity smart contract 430 can access the shared data 424 but is not aware of the private data 416 (e.g., sensitive information such as account holdings) or identity of the first entity. A second entity smart contract 430 includes BSP code 438 that accesses that the shared data 424. The BSP code 438 may perform one or more operations using the shared data 424. For example, the processing code 438 can include verification code that, when executed, verifies that the shared data 424 is consistent with the expectations of the second entity. As other examples, the processing code 438 may include code for performing one or more calculations using the shared data 424 or providing the shared data 424 for display, etc.

Similarly, a second bilateral projection smart contract 440 may be used to enable the first entity to view the shared data 434 of the second entity smart contract 430 without revealing the private data 436 of the second entity. The second bilateral projection smart contract 440 includes shared data 444 (which is copied form the shared data 434 of the second entity smart contract 430 but does not include the corresponding private data 436) and access permissions 442 indicating that the first and second entities (and potentially other relevant entities, such as custodians of the first and second entities) can access the shared data 434. The first entity smart contract 410 may also use processing code 418 to access and perform operations using the shared data 434 of the second entity smart contract 430 without providing the first entity with access to the identity or private data 436 of the second entity. For example, the processing code 418 may include validation code for validating that the shared data 434 is consistent with the expectations of the first entity, code for performing one or more calculations using the shared data 434, or code for providing the shared data 434 for display, etc.

In the embodiment shown in FIG. 4A, the first BSP 420 and second BSP 440 each provide for unidirectional communication between smart contracts. Specifically, the first BSP 420 enables the second entity smart contract 430 to access the shared data 414 of the first entity smart contract 410 and the second BSP 440 enables the first entity smart contract 410 to access the shared data 434 of the second entity smart contract 430. FIG. 4B illustrates an alternative configuration where a pair of projections may be used for two-way communication between smart contracts.

In FIG. 4B, a first entity smart contract 450 (having an owner ID 452) projects shared data 454 into a first BSP 460, with access permissions 462, which stores the projected data in shared data 464. Similarly, a second entity smart contract 470 (with an owner ID 472) projects shared data 474 into a second BSP 480, with access permissions 482, which stores the projected data in stored data 484. The access permissions 462, 482 enable the first BSP 460 and the second BSP 480 to access each other's shared data 464, 484. Thus, processing code 458 of the first entity smart contract 450 can act on the projection of shared data 474 of the second entity smart contract 470 (via the first BSP 460 and the second BSP 480) and vice versa, enabling two-way communication between the two smart contracts.

The BSPs described above are static, meaning that only data is shared from the underlying smart contract. However, in some embodiments, BSPs may active, meaning they can be used to share functionality of the underlying (private) smart contract. For example, a private smart contract may include a function to verify that the data within the private smart contract complies with one or more requirements. By sharing this function via a BSP, a second (private) smart contract may use the function to verify that the first (private) smart contract's data complies with the requirements without having access to the data itself.

When the state of an underlying smart contract changes, the projection in the BSP is updated accordingly, so that they are not stale. Some or all of the following techniques may be applied to prevent BSPs from becoming stale.

Proof Contracts: Proof contracts allow many contracts to lazily check the existence and current state of a reference contract. A reference contract issues multiple BSPs, one for each (group of) viewers. The reference contract's mutation and deletion code synchronously mutates or deletes all the BSPs (so they are guaranteed to never be stale). The viewers can lazily fetch the BSPs to check the reference state at the time they are taking some action, and test its existence and validate any data in it.

Subscriber Contracts: Subscriber contracts synchronously update contracts whenever the reference contract's state changes. A reference contract issues multiple BSPs, one for each (group of) viewers. Each BSP can be subscribed to by more than one of the viewers'contracts. The reference contract's mutation and deletion code synchronously announce the details of the mutation/deletion to all the BSPs, and the BSPs in turn synchronously call choices on their respective subscribed contracts to announce the mutation/deletion. The subscribed contracts can handle the mutation/deletion (and its specific details) with logic provided by the viewers.

Reference Counters: Reference counters block deletions (and applicable mutations) of a reference contract while it is still referred to elsewhere. A reference contract issues multiple BSPs (which may be referred to as reference counter projections), one for each viewer or groups of viewers. These reference counter projections contain a count field. The viewers'contracts include logic to keep the reference count (and any other data) on their respective reference counter projection up-to-date synchronously. The reference counter can lazily check the reference counter projection contracts at the time an action is taken, and in particular, confirm for any destructor it asserts that the sum of all the reference counts is zero before executing the destructor.

Based on the foregoing, it will be apparent to those of ordinary skill in the art that the disclosed platform 120 includes several technological improvements and advantages over existing digital asset transaction systems. Furthermore, the design of the platform 120 is conducive to easy upgrading and modification to meet specific needs.

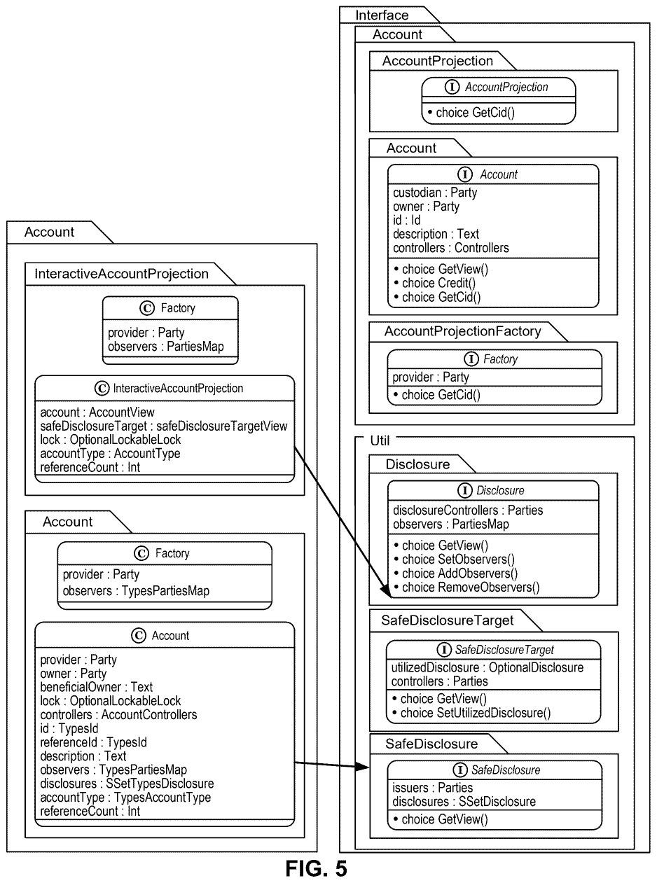

FIG. 5 illustrates example implementations of the templates, according to one embodiment. As will be appreciated by those of skill in the art, a pattern such as the example SelectiveDisclosure pattern allows the implementor to decide what level of detail to share. In the example embodiment described, the only requirement on the pattern level is that the source should implement a SafeDisclosure interface, and the projection should implement a SafeDisclosureTarget interface.

In this illustrated example implementation of account and projections, the projection contract only exposes the information used for settlement—which is partial account information such as the account balance and basic account information.

Privacy in settlement can be provided by performing settlement in such a way that total balances of holdings (tokens) in an account (and other private account data) is never disclosed in its entirety to the counterparty (and their custodians) or to the settlement agent (SA) that will execute the settlement instructions. As such, in contrast to conventional blockchain-based accounts that are typically entirely public, a wide range information can be stored on-chain to support advanced functionality without raising concerns that other parties will have access to sensitive information. Furthermore, this logic can be applied to any number of nodes (participants) within a custody hierarchy, and enable settlement between any two beneficiary accounts without revealing the account information and total holding balance. Moreover, rather than disclosing accounts directly during settlement, account projections are used. Account projections are a type of BSP (as described previously) where the underlying smart contract is an account. Thus, what information is disclosed to each entity may be restricted to the bare minimum required for settlement, ensuring protection of sensitive account information, while still guaranteeing integrity of the account and the holdings being used in the settlement.

When a settlement instruction (SI) is created, it describes the movement of tokens from specific account(s). Therefore, settlement instructions are closely linked to accounts. When an SI is created instructing the movement of tokens from an account, the account will be disclosed to the SA by creating an account projection. In addition, if the instruction is a debit instruction (i.e., tokens will be debited from the instructing account), holdings can be optionally disclosed to the SA to facilitate the settlement. This is optional because the instructor may not have sufficient balance at the time of creating an instruction. Furthermore, the owner of a smart contract may choose when and how much to disclose by one or more projections, which can be freely associated with and disassociated from the underlying private smart contract. As information that is shared with the projection changes, it is automatically updated using a subscriber pattern, as described previously. In various embodiments, this disclosure happens atomically.

Once all SIs have been received by the DAP, they are batched (connecting SIs that are part of the same transaction) and allocated. To ensure to all participants that the SA has correctly batched and executed the instructions without revealing all instructions to the counterparties, an optimistic verification algorithm (meaning it allows creation of instructions assuming they can be batched in a valid format) is employed upon the settlement of every instruction in a batch. When a batch is created, the batched instructions are validated by programmatically constructing the route and verifying the selectively disclosed accounts and holdings at each point.

In one embodiment, settlement is enabled using a pattern to disclose a subset of non-private DLT ledger information between the communicating participants. We refer to an example of such a pattern as a SelectiveDisclosure pattern.

In this example embodiment, the SelectiveDisclosure pattern projects a template to be viewed by a set of parties in a manner that avoids the viewing parties from seeing any other disclosures of the underlying template. A template that may be disclosed selectively can, in one embodiment, implement an interface such as a SafeDisclosure interface (see below). This will also track how many times the template has been projected/disclosed and tracks who it has been disclosed to. Similarly, a template that has been selectively disclosed can implement an interface such as a SafeDisclosureTarget interface. This stores details of the selectively disclosed observers to the contract.

In various embodiments, tokens (or holdings) are held in user accounts, and when tokens are pledged for settlement, some information must be disclosed to the settlement agent. As described above, described embodiments enable the account to be partially disclosed, with only the need-to-know information forming part of the disclosure.

As an example implementation, consider the following embodiment:
An Account template allow for selective disclosures.
In the context of settlement, the Account template selectively discloses information to the settlement agent.
   This disclosure results in creation of InteractiveAccountProjection, which implements the Account interface (and therefore contains a subset of the information stamped onto the Account, i.e. Account. View).
   This allows the Account to have private and sensitive information that is not required to be disclosed entirely to the settlement agent during settlement.
The InteractiveAccountProjection will has the same signatories as the Account.
The InteractiveAccountProjection implements SafeDisclosureTarget (described above), since it is the artifact that is disclosed.
Both InteractiveAccountProjection and Account have an option for either credit and debit.

For each account, there can be n projections (e.g., BSPs) with different sets of visibility. In one embodiment, referential integrity is maintained during the lifecycle of each projection as follows. Any credits and debits to either an Account or InteractiveAccountProjection cause the reference counter to be incremented or decremented, respectively. The criteria for account deletion ensures that reference count of the Account and all associated InteractiveAccountProjection are zero before deletion can take place.

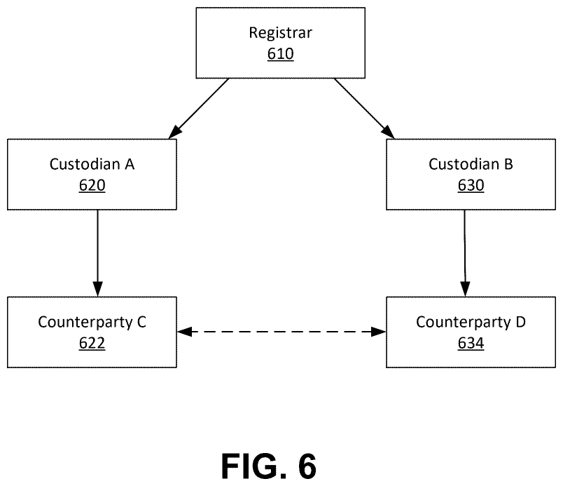

FIG. 6 shows a custody tree that illustrates the application of the verification algorithm using batching and atomic settlement to a typical transaction scenario, according to one embodiment. Specifically, counterparty C 622 and counterparty D 634 are engaged in a transaction to transfer tokens from C to D. Custodian A 620 is the custodian for counterparty C's relevant assets and Custodian B 630 is the custodian for counterparty D's relevant assets. A registrar 610 stores the relevant relationships between the custodians and counterparties. In this scenario, four settlement instructions are created (one for each of A, B, C, and D). When executing, C will not be aware of B or D's instructions, so it cannot directly verify that A transferred the correct tokens to B or that B transferred the correct tokens to D.

To address this, the instructions are batched and linked. Batching is the grouping of instructions in a transaction. Linking is making sure that instructions follow a valid route from seller to buyer. The linkage ensures settlement integrity while maintaining privacy. Client (counterparty) instructions are linked with their custodial instructions without triggering privacy concerns while transfer instructions are circularly linked. In other words, while C and D are not directly linked (as illustrated by the broken line in FIG. 6), the chain of links from C to D can each be independently verified, which logically verifies C and D relative to each other.

In the example shown in FIG. 6, this means that C's instruction will be linked to A, A will be linked to B, B will be linked to A, and D will be linked to B. When the instructions are executed, the smart contracts dictate that client instructions (C inx, D inx) can only be executed if the corresponding custodial instruction is of the same amount and has the same transaction information. Similarly, transfer instructions (A inx, B inx) will only execute if they are circularly linked and will always be executed atomically. Therefore, by executing a batch, the instructions can be settled with veracity without revealing the instructions to the transacting parties but by trusting the algorithm. Because the instructions are executed atomically, they either all succeed, guaranteeing agreement between C and D's instructions, or they all fail. In contrast, conventional techniques that do not settle atomically can result in transfer of assets along a portion of the chain, requiring complex clawback protocols to be employed if a failure occurs.

To provide an oversimplified example for illustrative purposes, if counterparty C 622 wishes to transfer Token T_{A} on Chain A to counterparty D 634 in exchange for Token T_{B} on Chain B, settlement instruction are created for: (1) counterparty C to release its interest in Token T_{A} on Chain A such that custodian A 620 is free to transfer it (counterparty C will also receive an interest in Token T_{B} token from custodian A); (2) custodian A to transfer custody of Token T_{A} on Chain A to custodian B 630 and record counterparty C's interest in Token T_{B} on Chain B; (3) custodian B to record the interest in Token T_{A} of counterparty D 634 on Chain A and transfer custody of Token T_{B} on Chain B to custodian A; and (4) counterparty D to release its interest in Token T_{B} on Chain B such that custodian B 630 is free to transfer it (counterparty D will also receive an interest in Token T_{A} from custodian B). Because each of these settlement instructions involve the same types of assets, the same amounts of assets, and have a party in common with another one of the settlement instructions, they can be identified as a batch and executed atomically together. Thus, either all of the settlement instructions execute successfully, resulting in the desired exchange of Token T_{A} for Token T_{B}, or all of them fail, resulting in the parties being in the same position they were in at the start.

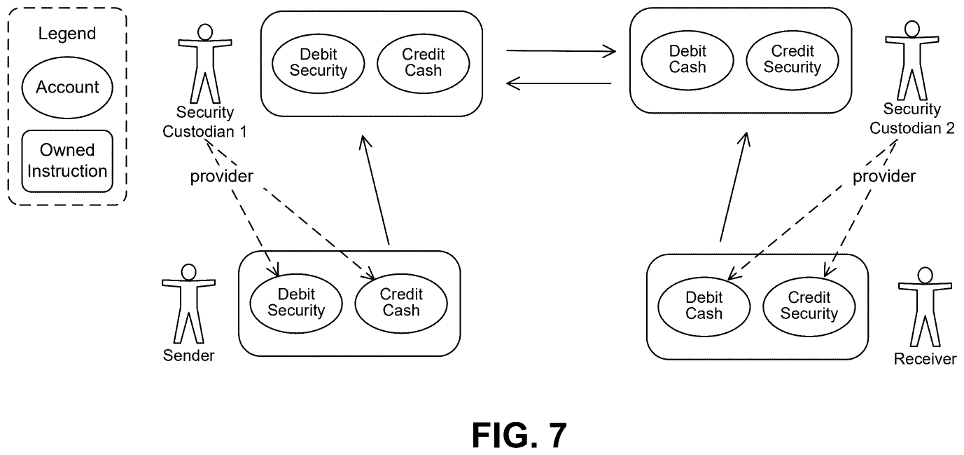

As a further example, in a DvP settlement, a sender agrees to receive and send assets atomically using a single contract rather than using different contracts to approve the delivery and payment. FIG. 7 illustrates the movement of cash and securities for a transaction using self-contained owned instruction smart contracts with batching and atomic settlement, according to one embodiment. A person having ordinary skill in the art will appreciate how FIG. 7 is a specific example of the general structure illustrated and described with reference to FIG. 6. This design can be used as a base to build more complex settlement chaining with a focus on privacy. For example, a custody tree can be built for broker trades, where the delivery of one settlement can be used to settle subsequent trades, without revealing the balance beforehand.

As can be inferred from, and to summarize the description and examples above, every trade follows a settlement process to exchange the assets between the buyer and the seller-often passing through several accounts in the custody structure. To preserve privacy between the counterparties and the settlement facilitator, a projection is created for each party which is shared with the settlement agent. This enables, for example, the SA to confirm that the counterparty has enough tokens agreed for settlement while not fully disclosing the complete balance and the other settlements they are part of.

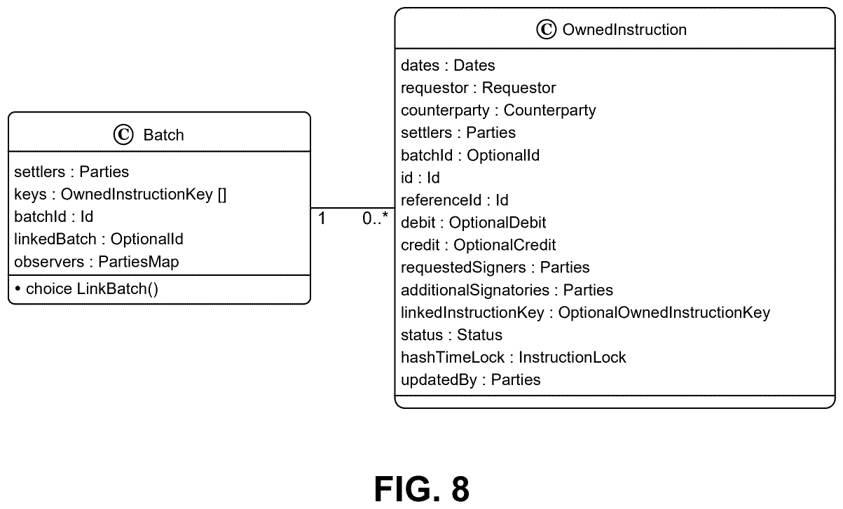

The batching process further ensures that there is a valid custody hierarchy and approvals to carry out the settlement. FIG. 8 illustrates the structure of example batch and owned instruction smart contacts used during settlement, according to one embodiment.

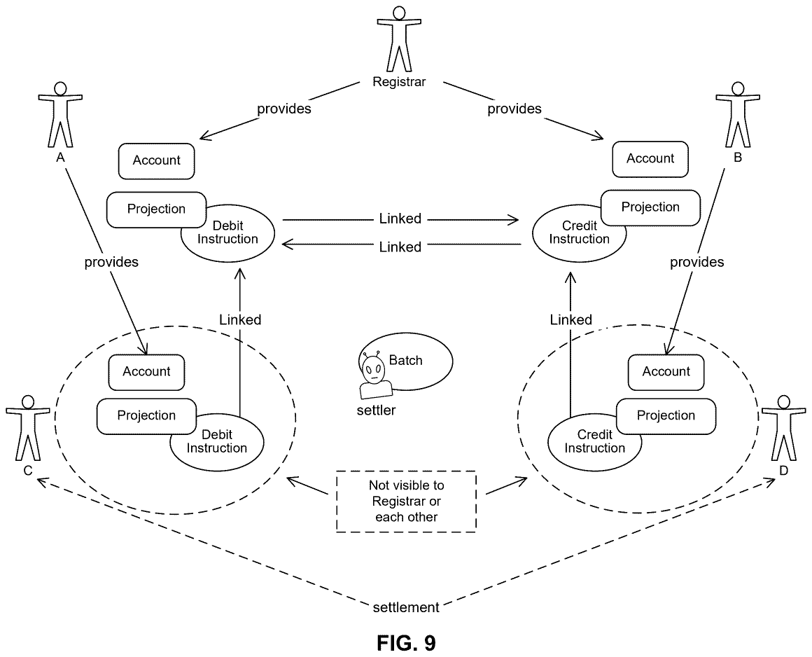

FIG. 9 also illustrates the batching of instructions and atomic settlements in one potential scenario, which is another specific example of the general principle illustrated by FIG. 6. In this scenario, C and D are trading counterparties while A and B are custodians for C and D, respectively. For the trade between C and D, four settlement instructions are created, one for each account. These instructions are linked, batched, and executed by the settlement agent. For each instruction, a respective account projection can be created which is shared with the settlement agent. Thus, when executing, C will not see instructions B and D, but batching and instruction linking enable C to know that D indeed received the tokens. Specifically, batching enables C to proceed with confidence that its custodian A is moving the same number of tokens without seeing the instructions themselves. As noted, batching includes the grouping of instructions in a trade, and linking ensures that instructions follow a valid route from seller to buyer. The linkage ensures settlement integrity while maintaining privacy as well as ensuring lateral movement of tokens will always happen atomically, even if a malicious actor tries to circumvent the settlement process (i.e., linked instructions either atomically credit/debit tokens or all fail). Client instructions will always be linked with their custodial instructions and lateral instructions will always be circularly linked. In various embodiments, all instructions are required to be linked to exactly one other instruction. There are a variety of rules and algorithms employed to ensure that valid links are created and verified at the settlement, including economics-based matching, ensuring that all instructions follow a valid route of parties/custody relationships, ensuring that there is exactly one lateral movement of tokens, etc.

In the scenario above, the instruction of C is linked to A, A is linked to B, B is linked to A, and D is linked to B. The linkage between C to A and D to B is defined as custodial movements and the circular linkage between A and B is defined as lateral movement. When the instructions are executed, the smart contracts dictate that client instructions (Instruction of C, Instruction of D) can only be executed if the corresponding custodial instruction is of the same amount and has the same trade information. Similarly, transfer instructions (Instruction of A, Instruction of B) will only execute if they are circularly linked and will always be executed atomically. Therefore, by executing a batch, the instructions can be settled with veracity without revealing the instructions to the trading parties, but the parties can trust the algorithm and have confidence that all steps of the trade are completed correctly.

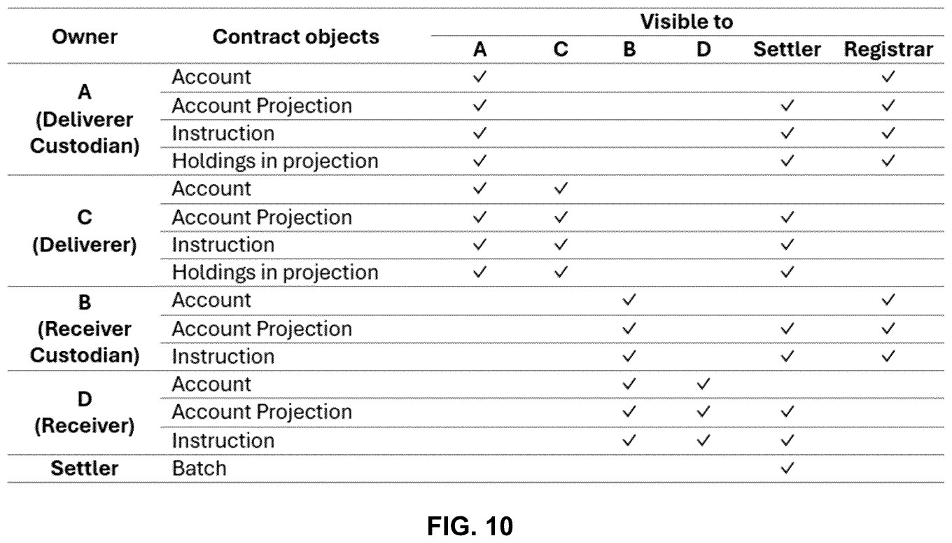

FIG. 10 illustrates the visibility matrix of the contracts involved right before the settlement in the example of FIG. 9. Once settled the Holdings (tokens) are moved from the deliverer to receiver and all visibility can be removed. For example, the access permissions for the corresponding smart contracts may be set to not allow anyone to have viewing permissions, the smart contracts can be archived, or both. It should be appreciated that for other transactions, other combinations of smart contracts may be used with appropriate access permissions to preserve privacy while enabling all parties to have access to the information needed to complete settlement.

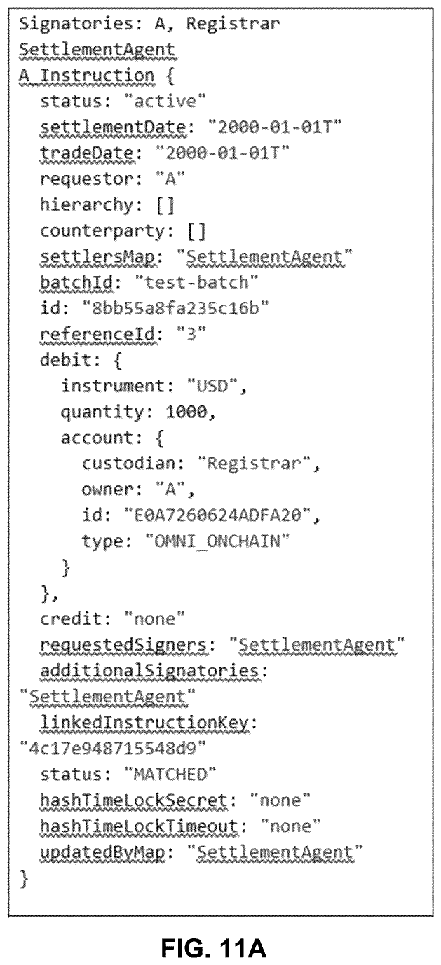

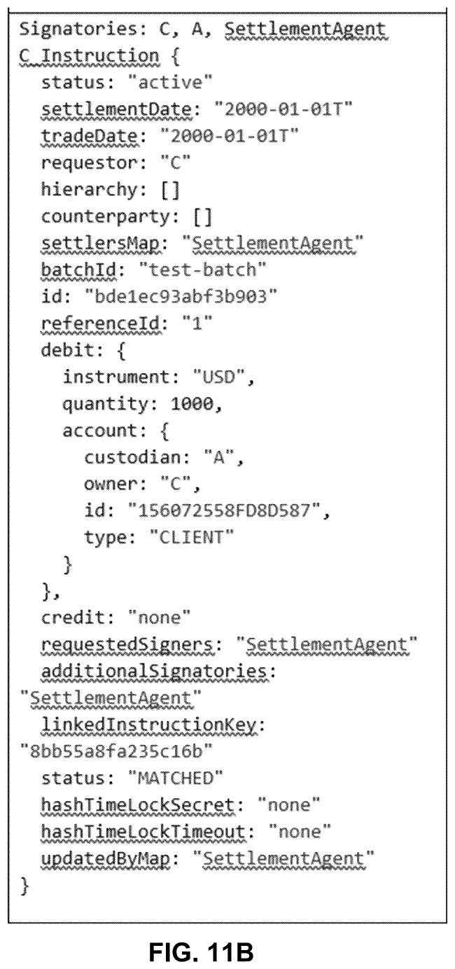

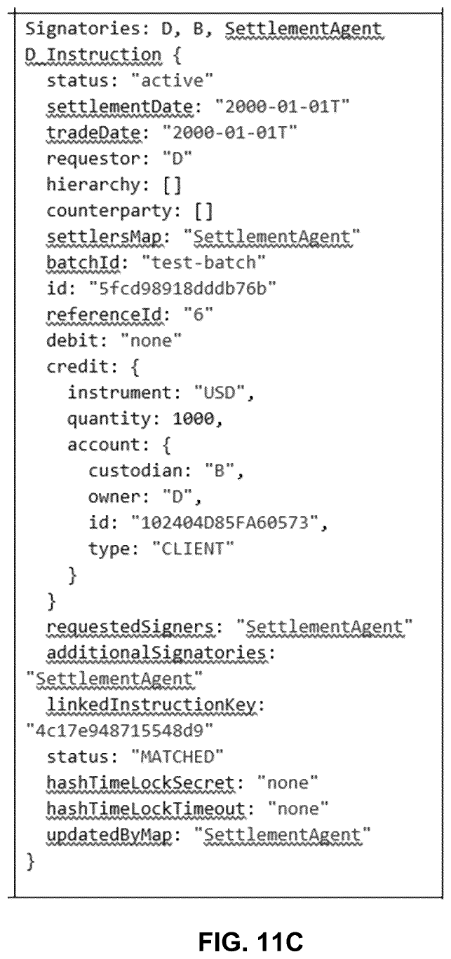

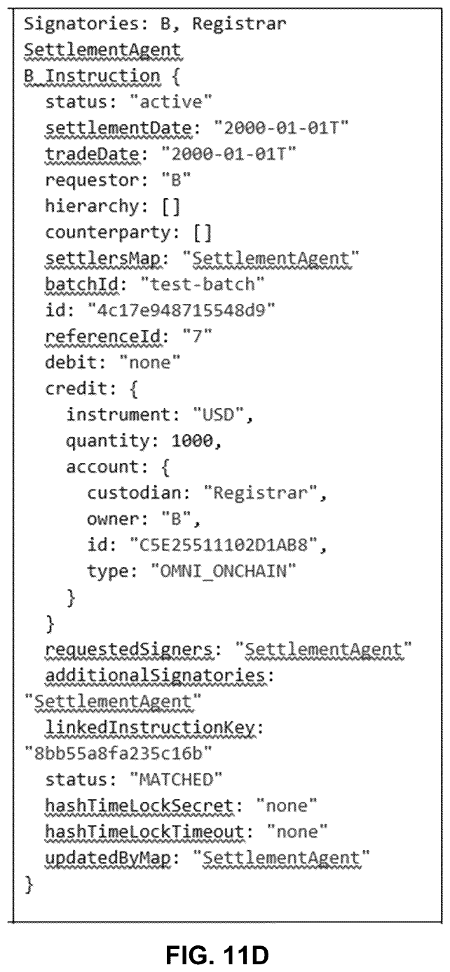

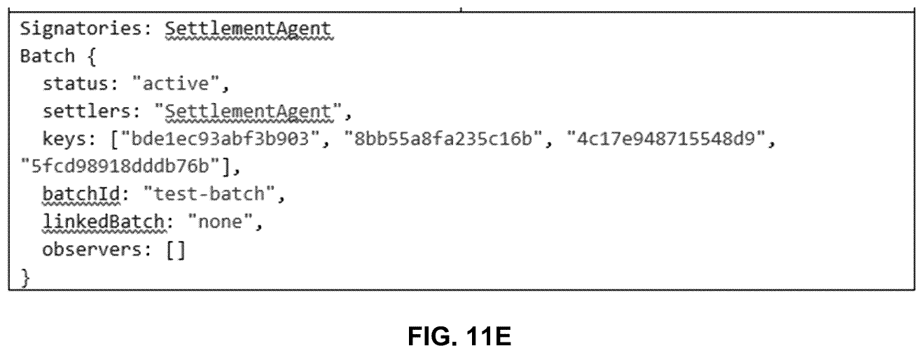

FIG. 11A, B, C, D, and E illustrate example detailed batch and settlement objects after they are batched together and ready to be settled. Each object includes settlement instructions, identifies the parties that will (or have) signed, and indicates the current status of the object.

### Use of Extracted Method Contracts

In one embodiment, the platform 120 makes use of extracted method contracts. An extracted method contract is a smart contract with a choice-implementing function that behaves independently of the contract's state (possibly aside from the datum of the extracted method contract's signatory). For example, an application may deliver the functionality of executing a payment, and part of that functionality is a complex validation that the payment quantity is within a set of the rules (which may specify maximum/minimum/denomination values, or a rule for retrieving these values, etc.). Instead of writing a single smart contract containing the full implementation logic, the implementation can be split into two contracts: (1) a main smart contract implementing most of the implementation logic; and (2) a separate smart contract (in a separate DAR) implementing the payment quantity validation piece. The main contract can either call out to the validation contract to synchronously assert the validity, or it can wait for the validation contract to send an attestation of validity (note the “wait” is not necessarily asynchronous in practice).

The advantage of this pattern is that an upgrade can be executed with only a few contract replacements (of the extract method contract(s)), with fewer replacements than replacing every application contract, because multiple instances of the application contract can share a single instance of the extracted method contract. The minimum number of extracted method contract instances is therefore one, and the minimum number of extracted method contracts needed to do this with no additional data disclosure equals the number of nodes in the platform 120.

Another design feature that is used in some embodiments to provide upgradability are retroactive upgrading interfaces implemented using smart templates. These retroactive upgrading interfaces may perform a complete upgrade without requiring any actions from anyone other than node operators. Furthermore, this approach enables upgrades that are highly flexible with regard to how the code is written, with few if any requirements for structure and content of the code.

For templates being upgraded with no schema change, a single retroactive interface that has a choice “upgrade,” with the controller being a single party, can be written and retroactively implemented on all of those templates. For templates that are having a schema change, a separate retroactive interface contract can be written for every such schema-changing template, with a single choice, “upgrade,” with appropriate parameters as necessary for the schema conversion logic and for additional data, again with only a single party as controller.

Once the DAR full of upgrader retroactive interfaces has been created, published, and uploaded to nodes, the smart contracts upgrading process proceeds automatically. The upgraders'choices have only a single controller, removing the need to coordinate and accumulate signatures from parties on different nodes using conventional “upgrade proposal” contracts. Instead, each upgrade contract uses a single method call with the authority of a single party. Therefore, the number of operations required is equal to the number of contract instances across all templates across all DARs being updated. This is significantly less operations than is typically required using conventional upgrade approaches.

In one embodiment, coordination of the upgrade process includes each node uploading the DAR of the new version of the package and the DAR of upgrader retroactive interfaces. Each node operator naturally knows which templates they are responsible for upgrading because the upgrader retroactive interfaces define rule(s) that identify, for every contract, a specific party expected to do the upgrade, and the node operator knows if that party is hosted on their node or not. Each node operator can award themselves an “act as” token for any party hosted on their node. On an agreed schedule, which may be a rolling or A/B approach, node operators upgrade contract instances. The node operators give themselves an “ActAs” token as the party responsible for upgrading that contract, call the “upgrade” method, and, if the “upgrade” method includes handling a schema change that requires parameters, provide the required parameters.

### Example Tiered Hierarchical Account Structure

FIG. 12 illustrates one embodiment of a tiered hierarchical account structure which has the custodian holding securities within tier-one accounts and provides claim tokens for digital assets within tier-two accounts. In the embodiment shown, the account structure is arranged in a hierarchy with three tiers. However, there may in principle be any number of tiers within the hierarchy. Each additional tier enables providers holding tokens in the tier above to further split the ownership or beneficial interests represented by those tokens into parts, represented by further tokens in the lower tier. The tiers may all be stored on a single blockchain with permissions being used to control what information each participating entity may view. Alternatively, an entity that has custody of an asset in tier one can operate a separate blockchain to record beneficial interests in the assets over which it has custody.

Tier one 1210 of the hierarchical account structure handles digital custody of the assets themselves. Custody of the digital assets is typically limited to a small number of qualified institutional investors depending on jurisdictional requirements (e.g., some jurisdictions do not allow institutional investors to do self-custody). Controls are implemented to only allow the owners of the accounts to transfer/move the assets within the accounts as well as to view the holdings. Tier-one accounts may provide ownership or beneficial interests in the assets over which they have custody to other users, may hold the assets as self-custodians for their own benefit, or both. In the embodiment shown in FIG. 12, tier one 1210 includes a securities issuance account 1211 (to contain the asset when it is first originated on the ledger), one or more tier-one investor risk accounts 1212, a first tier-one provider risk account 1214, a tier-one provider omnibus-client account 1215, a second tier-one provider risk account 1216, and one or more tier-one segregated accounts 1217. As described previously, each account may be a blockchain address or wallet or an account defined within the ledger, depending on the DLT technology used. In other embodiments, tier one 1210 may include different or additional elements. For example, any number of providers may have risk and omnibus client/segregated accounts in the tier one ledger 1210.

The securities issuance account (or securities issuance record) 1211 is where the initial issuance of a set of assets is recorded. Thus, information about the assets and the number of assets issued is stored using a smart contract, which may be used for reconciliation against the tier one asset holdings. The securities issuance account 1211 is different from a transaction account (used to store the securities). The securities issuance account 1211 does not have custody of the assets nor indicate legal ownership of the assets, rather it serves as a registration of the assets.

The tier-one investor risk accounts 1212 are for accounts that are authorized to transact in the first-tier ledger 1210 (e.g., institutional investors) that wish to self-custody (i.e., hold accounts directly with the registrar) of the asset. The tier-one investor risk accounts 1212 hold investor principal positions

In the example shown, there is both a tier-one omnibus client account 1215 (which stores tokens for multiple entities in a single account) and one or more tier-one segregated accounts 1217 (with each segregated account storing tokens for a single entity). Depending on local regulatory requirements and client preferences, the hierarchy may use just a tier-one omnibus client account 1215, only a set of tier-one segregated accounts 1217, or a combination of both (e.g., where local law and regulations allow omnibus accounts but one or more clients elect to us segregated accounts). Furthermore, although specific numbers of various types of account are shown, the first tier may include accounts of each type for any number of providers that make investment in the digital assets available to second-tier users.

In some embodiments, providers may have a risk account and a holding account. The purpose of the custodian to hold a risk account and omnibus account is to segregate the clients'custody assets (kept in the client omnibus account) versus its propriety assets (kept in risk account). However, in typical configurations, custodians do not hold proprietary assets and thus do not need (and thus may not have) risk accounts. That said, for the sake of completeness, FIG. 12 shows a first tier-one provider risk account 1214 that may hold digital assets that the custodian holds on its firm-capacity and a tier-one provider omnibus client account 1215 that has custody over digital assets for which the provider makes ownership or beneficial interests available to second-tier users as well as digital assets over which other tier-one participants have custody. Similarly, the second tier-one provider risk account 1216 has custody over digital assets held by the second provider for principal investment. However, the second provider has a tier-one segregated account 1217 in which it holds digital assets for which it provides beneficial interests to second-tier users that are segregated from digital assets for which other tier-one participants are the custodian.

Accounts in the second tier hold tokens representing ownership or beneficial interests in the digital assets that sits in the custodian-managed account in tier one 1210. The second-tier accounts do not have custody over the digital assets themselves instead they hold claims issued by the respective securities custodian. This may be implemented by an ownership or beneficial interest smart contract that is signed by the custodian account. In the embodiment shown in FIG. 12, the second tier includes a first portion 1220 and a second portion 1230. Each tier-two portion corresponds to a different custodian in tier one. In one embodiment, the accounts in the tier-two portions 1220 and 1230 are part of the same ledger that includes the tier-one accounts. Alternatively, some or all of the tier-two accounts may be stored on different ledgers. Note that although the first tier-two portion 1220 is shown as branching from tier-one omnibus client account 1215 and the second tier-two portion 1230 is shown as branching from a tier-one segregated account 1217, the tier-two portions may branch off any combination of the tier-one omnibus client account, segregated accounts, or both.

The first tier-two portion 1220 is for the first tier-one provider. In this case, the first tier-one provider/custodian safeguards the securities for the tier-two clients by holding the securities in the omnibus account and indicating the ownership or beneficial interests in the digital assets to tier-two accounts using claim tokens issued by the custodian held within the tier-two accounts, but none of those secondary users further divide the ownership or beneficial interests for tier-three accounts. Thus, the accounts in the first tier-two portion 1220 hold the digital assets for the tier-two investors. The digital assets holdings in the custodian omnibus account reconciles against the claim tokens that sit in the tier-two investor accounts provided by the custodian. When a tier-two user invests in the digital assets for which the first tier-one provider is a custodian, a token representing an ownership or beneficial interest in the digital assets (or a portion of a digital asset) is added to the tier-two user's account 1222.

The second tier-two portion 1230 similarly includes second tier-two investor accounts 1232 that may store claim tokens (issued by the custodian) representing ownership or beneficial interests in digital assets (or portions of a digital asset) for which the second tier-one provider is custodian. The second tier-two portion 1230 can include an omnibus client account 1236 that further subdivides the ownership or beneficial interests it holds and makes the parts of the subdivided ownership or beneficial interest available to third-tier investors, tier-two segregated accounts that store tokens representing beneficial interests held by individual tier-two participants, or a combination of both. The tier-two omnibus client account 1236 functions similarly to a tier-one omnibus client account (e.g., tier-one omnibus client account 1215) except that rather than being a custodian of a digital asset, the tier-two omnibus client account 1236 holds ownership or beneficial interests in an asset for multiple tier-two participants, some or all of whom may make ownership or beneficial interests in those interests available to third-tier investors. The tier-two segregated accounts 1238 are similar to the tier-one segregated accounts 1217 except that they store ownership or beneficial interests of individual tier-two participants, some or all of whom may make ownership or beneficial interests in those interests available to third-tier investors.

Tier three 1240 includes accounts 1242 of tier-three users that obtain ownership or beneficial interests from a tier-two provider. It should be noted that the tier-three ledger 1240 may also include one or more provider accounts that make ownership or beneficial interests in the digital assets available to fourth-tier users, and so on up to an arbitrary number of tiers. An advantage of using the tiered structure shown in FIG. 12 is that it provides privacy control and only allows the account provider to know the clients holding and provides that reconciliation holds between the assets they custody for and the number of claim tokens issued to custody clients. For example, the second tier-one provider may only need to know what ownership or beneficial interests it has given to tier-two users. It may not need to know whether the tier-two users are holding these interests for their own benefit or have further passed them on to tier-three users. Furthermore, as the tier-one users remain custodians of the digital assets, when ownership or beneficial interests are traded on tier two 1220 and 1230, tier one 1210 can remain unchanged. Similarly, tier two 1220 and 1230 may remain unchanged if beneficial interests are exchanged or traded in tier three 1240, etc.

Another advantage of the hierarchical structure is that different tier-two (or lower) portions may be used to provide trading of ownership or beneficial interests in different jurisdictions. Each tier-two portion 1220, 1230 may be configured to comply with local regulatory requirements for the trading of securities. Thus, tier one 1210 may be universal and include custody of the underlying digital assets while tier two can provide trading of securities of the same underlying assets to different markets with different regulatory requirements.

### Example Methods

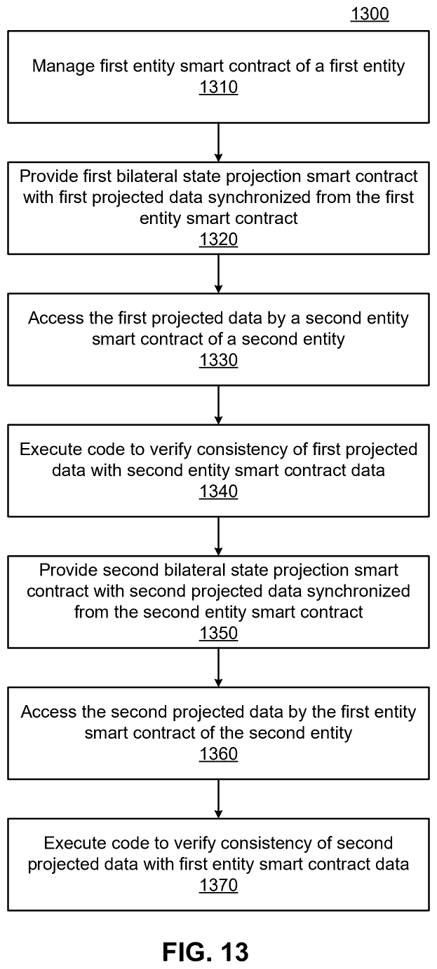

FIG. 13 illustrates an example method 1300 for verifying consistency between smart contracts while preserving privacy, according to one embodiment. The steps of FIG. 13 are illustrated from the perspective of the digital assets platform 120 performing the method 1300. However, some or all of the steps may be performed by other entities or components. In addition, some embodiments may perform the steps in parallel, perform the steps in different orders, or perform different steps.

In the embodiment shown, the method 1300 includes the digital assets platform 120 managing 1310 a first entity smart contract. The first entity smart contract stores an identifier of the first entity, shared data of the first entity, and private data of the first entity. The digital assets platform 120 provides 1320 a first bilateral state projection smart contract that stores access permissions and projected data. The access permissions indicate that the first entity and a second entity can access the bilateral state projection smart contract and the projected data is synchronized with the shared data of the first entity in the first entity smart contract, without including the private data of the first entity.

The method 1300 also includes a second entity smart contract accessing 1330 the projected data in the first bilateral state projection smart contract. The second entity smart contract includes validation code that is executed 1340 to verify the consistency of the projected data with data in the second entity smart contract. Thus, the method 1300 enables verification that the public data in the first entity smart contract matches the expectations of the second entity while retaining privacy of the first entity by not providing the second entity with access to the first entity's private data.

In some embodiments, the verification can be two-way, meaning the first entity can also verify that the second entity's public data matches the first entity's expectations without providing the first entity access to the second entity's private data. Specifically, the method 1300 may also include providing 1350 a second bilateral state projection smart contract that includes second access permissions and second projected data. The second access permissions indicate that the first and second entity can access the second bilateral state projection smart contract and the second projected data is synchronized with the public data of the second entity, without including private data of the second entity. The first entity smart contract accesses 1360 the second projected data and executes 1370 code to verify that the second projected data is consistent with the expectations of the first entity (e.g., that the second projected data is consistent with the public or private data of the first entity).

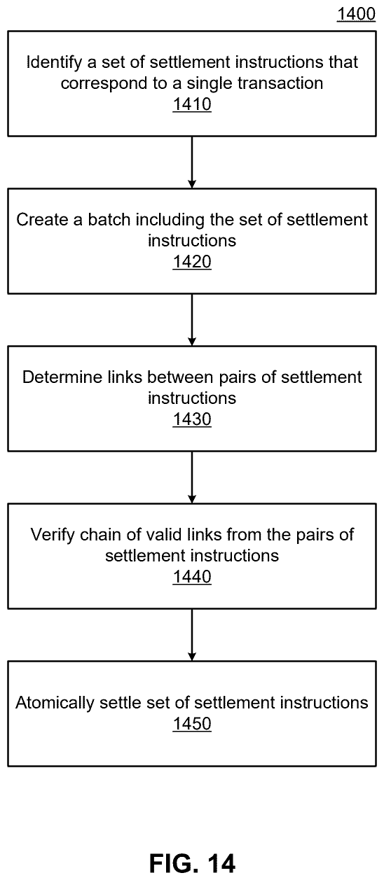

FIG. 14 illustrates a method 1400 of atomically settling a set of settlement instruction, according to one embodiment. The steps of FIG. 14 are illustrated from the perspective of the digital assets platform 120 performing the method 1400. However, some or all of the steps may be performed by other entities or components. In addition, some embodiments may perform the steps in parallel, perform the steps in different orders, or perform different steps.

In the embodiment shown, the method 1400 begins with the digital assets platform 120 identifying 1410 a set of settlement instructions that correspond to a single transaction. Each settlement instruction may be associated with a smart contract controlled by a corresponding entity on a distributed ledger. As described previously, settlement instructions can be identified 1410 as corresponding to a single transaction based on them involving one or more of the same type of assets, the same amount of assets, or one or more parties in common. Regardless of precisely how they are identified 1410, a batch including the set of settlement instructions is created 1420.

The digital assets platform 120 determines 1430 links between pairs of settlement instructions in the batch. The pairs on settlement instructions can be used to verify 1140 that a chain of valid links from a source entity that is attempting to transfer a digital asset to a target entity (with each of the source and target entities control a corresponding one of the smart contracts). In response to verifying 1440 a valid chain of links exists, the digital assets platform 120 atomically settles 1450 the batched settlement instructions. Thus, the digital assets is transferred from the source entity to the target entity.

### Computing System Architecture

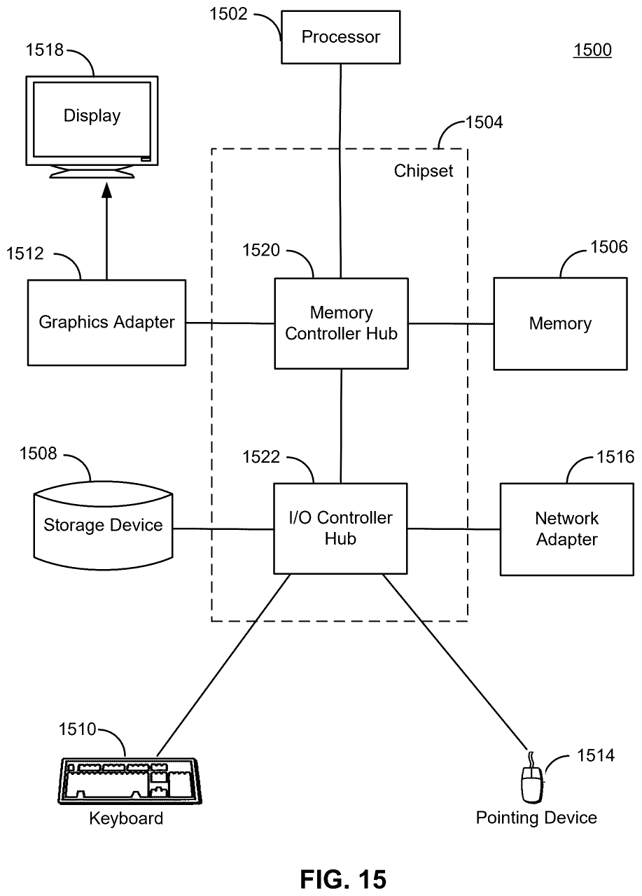

FIG. 15 illustrates an example computer 1500 suitable for use as part of the digital assets platform 120, a client device 140, or a distributed node 112 or 114, according to one embodiment. The example computer 1500 includes at least one processor 1502 coupled to a chipset 1504. For convenience, various operations may be described as being performed by “a processor 1502.” It should be understood that this means that the stated operations are performed by one or more processors working either individually or cooperatively. The chipset 1504 includes a memory controller hub 1520 and an input/output (I/O) controller hub 1522. A memory 1506 and a graphics adapter 1512 are coupled to the memory controller hub 1520, and a display 1518 is coupled to the graphics adapter 1512. A storage device 1308, keyboard 1510, pointing device 1514, and network adapter 1516 are coupled to the I/O controller hub 1522. Other embodiments of the computer 1500 have different architectures.

In the embodiment shown in FIG. 15, the storage device 1508 is a non-transitory computer-readable storage medium such as a hard drive, compact disk read-only memory (CD-ROM), DVD, or a solid-state memory device. The memory 1506 holds instructions, e.g., to perform the methods described above, and data used by the processor 1302. The pointing device 1514 may be a mouse, track ball, touchscreen, or any other type of pointing device, and may be used in combination with the keyboard 1510 (which may be an on-screen keyboard) to input data into the computer system 1500. The graphics adapter 1512 causes images and other information to be displayed on the display 1518. The network adapter 1516 couples the computer system 1500 to one or more computer networks (e.g., network 190). The types of computers used by the entities of FIG. 1 can vary depending upon the embodiment and the processing power required by the entity. Furthermore, the computers can lack some of the components described above, such as keyboards 1510, graphics adapters 1512, and displays 1518.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing end-to-end registry, custody, issuance, trading, settlement, and servicing of digital assets and tokenized assets. Thus, while particular embodiments and applications have been illustrated and described, it is to be understood that the described subject matter is not limited to the precise construction and components disclosed. The scope of protection should be limited only by the following claims.

1. A computer-implemented method of operating on data across smart contracts while preserving privacy, the computer-implemented method comprising:
identifying a first entity smart contract, the first entity smart contract storing an identifier of the first entity, shared data of the first entity, and private data of the first entity;
creating a bilateral state projection smart contract that stores access permissions and projected data, the access permissions indicating the first entity and a second entity can access the bilateral state projection smart contract, and wherein the projected data includes the shared data of the first entity but not the private data of the first entity;
accessing the projected data by a second entity smart contract of the second entity, the second entity smart contract including second entity data and processing code; and
executing the processing code to perform an operation, by the second entity smart contract, using the projected data.

2. The computer-implemented method of claim 1, wherein the projected data is synchronized with the shared data.

3. The computer-implemented method of claim 1, further comprising:
creating a second bilateral state projection smart contract that stores second access permissions and second projected data, the second access permissions indicating the first entity and a second entity can access the second bilateral state projection smart contract and the second projected data including shared data of the second entity;
accessing the second projected data by the first entity smart contract, the first entity smart contract further including second processing code; and
executing the second processing code to perform an operation, by the first entity smart contract, using the second projected data.

4. The computer-implemented method of claim 1, wherein the second entity data includes public data of the second entity and private data of the second entity.

5. The computer-implemented method of claim 1, wherein the operation using the projected data comprises verifying the projected data is consistent with the second entity data.

6. The computer-implemented method of claim 1, further comprising:
providing a reference counter that includes a count of how many other smart contracts refer to the bilateral state projection smart contract;
receiving a request to execute a destructor of the bilateral state projection smart contract; and
responsive to the count having a value other than zero, preventing execution of the destructor of the bilateral state projection smart contract.

7. The computer-implemented method of claim 1, wherein the access permissions further indicate that a settlement agent smart contract can access the bilateral state projection smart contract, the settlement agent smart contract using the shared data of the first entity to facilitate settlement between the first entity and the second entity.

8. The computer-implemented method of claim 7, further comprising:
creating a settlement instructions smart contract including second access permissions and one or more settlement instructions, the second access permissions indicating that the settlement agent, but not the second entity, can access the one or more settlement instructions, and the one or more settlement instructions being part of a set of settlement instructions that are executed to facilitate a transaction.

9. The computer-implemented method of claim 8, wherein the second access permissions further indicate that a custodian of the first entity can access the settlement instructions smart contract, and the one or more settlement instructions define a transfer of an asset from the first entity to the custodian of the first entity as a first step in transferring the asset to the second entity.

10. A non-transitory computer-readable medium comprising stored instructions for operating on data across smart contracts while preserving privacy, the stored instructions, when executed, causing a computing system including one or more computing devices to perform operations comprising:
identifying a first entity smart contract, the first entity smart contract storing an identifier of the first entity, shared data of the first entity, and private data of the first entity;
creating a bilateral state projection smart contract that stores access permissions and projected data, the access permissions indicating the first entity and a second entity can access the bilateral state projection smart contract, wherein the projected data includes the shared data of the first entity but not the private data of the first entity;
accessing the projected data by a second entity smart contract of the second entity, the second entity smart contract including second entity data and processing code; and
executing the processing code to perform an operation, by the second entity smart contract, using the projected data.

11. The non-transitory computer-readable medium of claim 10, wherein the projected data is synchronized with the shared data.

12. The non-transitory computer-readable medium of claim 10, wherein the operations further comprise:
creating a second bilateral state projection smart contract that stores second access permissions and second projected data, the second access permissions indicating the first entity and a second entity can access the second bilateral state projection smart contract and the second projected data including shared data of the second entity;
accessing the second projected data by the first entity smart contract, the first entity smart contract further including second processing code; and
executing the second processing code to perform an operation, by the first entity smart contract, using the second projected data.

13. The non-transitory computer-readable medium of claim 10, wherein the second entity data includes public data of the second entity and private data of the second entity.

14. The non-transitory computer-readable medium of claim 10, wherein the operation using the projected data comprises verifying the projected data is consistent with the second entity data.

15. The non-transitory computer-readable medium of claim 10, wherein the operations further comprise:
providing a reference counter that includes a count of how many other smart contracts refer to the bilateral state projection smart contract;
receiving a request to execute a destructor of the bilateral state projection smart contract; and
responsive to the count having a value other than zero, preventing execution of the destructor of the bilateral state projection smart contract.

16. The non-transitory computer-readable medium of claim 10, wherein the access permissions further indicate that a settlement agent smart contract can access the bilateral state projection smart contract, the settlement agent smart contract using the shared data of the first entity to facilitate settlement between the first entity and the second entity.

17. The non-transitory computer-readable medium of claim 16, wherein the operations further comprise:
creating a settlement instructions smart contract including second access permissions and one or more settlement instructions, the second access permissions indicating that the first entity and the settlement agent, but not the second entity, can access the one or more settlement instructions, and the one or more settlement instructions being part of a set of settlement instructions that are executed to facilitate a transaction.

18. The non-transitory computer-readable medium of claim 17, wherein the second access permissions further indicate that a custodian of the first entity can access the settlement instructions smart contract, and the one or more settlement instructions define a transfer of an asset from the first entity to the custodian of the first entity as a first step in transferring the asset to the second entity.

19. (canceled)

20. (canceled)

21. A computing system comprising:
one or more processors; and
one or more memories storing instructions that, when executed by the one or more processors, cause the computing system to perform operations including:
identifying a first entity smart contract, the first entity smart contract storing an identifier of the first entity, shared data of the first entity, and private data of the first entity;
creating a bilateral state projection smart contract that stores access permissions and projected data, the access permissions indicating the first entity and a second entity can access the bilateral state projection smart contract, wherein the projected data includes the shared data of the first entity but not the private data of the first entity;
accessing the projected data by a second entity smart contract of the second entity, the second entity smart contract including second entity data and processing code; and
executing the processing code to perform an operation, by the second entity smart contract, using the projected data.

22. The computing system of claim 21, wherein the operations further include:
creating a second bilateral state projection smart contract that stores second access permissions and second projected data, the second access permissions indicating the first entity and a second entity can access the second bilateral state projection smart contract and the second projected data including shared data of the second entity;
accessing the second projected data by the first entity smart contract, the first entity smart contract further including second processing code; and
executing the second processing code to perform an operation, by the first entity smart contract, using the second projected data.
